(19) United States
(12) Patent Application Publication
(10) Pub. No.: US 2025/0341277 A1
(43) Pub. Date: Nov. 6, 2025

(54) Universal Caddy For Hand-Held Electronic Devices

(71) Applicant: Anthony Lombardi, Murfreesboro, TN (US)

(72) Inventor: Anthony Lombardi, Murfreesboro, TN (US)

(21) Appl. No.: 18/655,881

(22) Filed: May 6, 2024

(51) Int. Cl. F16M 13/06; F16M 11/22; F16M 13/02

(52) U.S. Cl. CPC F16M 13/06; F16M 11/22; F16M 13/022

(57) ABSTRACT

A universal caddy comprising a top portion which can be releasably secured to a shelf or cabinet, a main body portion for holding a small electronic device and a base portion which can be utilized on a flat surface. More particularly, the universal caddy has dual functionality, as a free-standing holder for an electronic device such as a smart phone or smart tablet and as an elevated device releasably secured to a shelf or cabinet.

### FIELD OF INVENTION

The present invention relates a universal caddy particularly for hand-held electronic devices such as smart phones and smart tablets in which the smart device is rested and held in place. The universal caddy is designed to provide dual functionality and can be utilized as a free-standing holder on a flat surface and can be elevated by releasably securing the universal holder onto a shelf or cabinet.

### BACKGROUND OF THE INVENTION

The prior art is replete with devices which are designed to hold small electronic devices such as smart phones thereby providing the user with a hands-free experience. Currently, device holders exist that can be clamped or otherwise secured to a cabinet of shelf. In some instances, these device holders are permanently mounted or affixed to the cabinet, shelf or wall and the user simply rests the smart phone on the device. Usually, these mounts are not aesthetically pleasing. The prior art devices for securing a smart phone or tablet in an elevated position are not capable of also functioning as a universal stand for the smart device. Other smart phone holders are simple free-standing holders that rest on a desk, table top or countertop. A variant of such a stand is one capable of charging the smart phone while resting on the stand. These stands are not capable of being elevated to a shelf or cabinet.

### PRIOR ART

U.S. Pat. No. 9,282,841 to Blair discloses an electronic tablet mount for engaging a shelf, and particularly a cabinet shelf. The mount provided by Blair does not have dual functionality and cannot be disposed on a flat surface as a free-standing device holder. In contrast, U.S. Patent Application Publication 2012-0119047A1 to Lumpkin et al. provides an electronic device holder which functions as a free-standing device holder. Lumpkin et al. does not contemplate dual functionality to adapt its device holder to be used in an elevated mounted position. Similarly, U.S. Pat. No. 6,366,672 to Tsay, U.S. Patent 9,134,808 to Siddiqui et al. and U.S. Patent Application Publication 2013/0068915A1 to Yang et al., all relate to a free-standing apparatus for holding or retaining a smart phone. None consider adapting the disclosed devices for releasably securing to a shelf or cabinet.

### SUMMARY OF THE INVENTION

The invention of the present subject matter relates to a universal caddy having dual functionality, first as a free-standing device for holding small electronic devices such as smart phones and smart tablets and second as an elevated device that can be quickly and easily adapted to be releasably secured to a shelf or cabinet.

Accordingly, it is an object of the present subject matter to provide a universal caddy for small hand-held electronic devices which has dual functionality as a free-standing holder and releasably securable to a shelf or cabinet.

It is another object of the present subject matter to universal caddy for hand-held electronic devices which can be utilized as a free-standing holder.

It is a further object of the present subject matter to provide universal caddy which can be elevated easily and quickly and be releasably secured to a shelf or cabinet.

It is an additional object of the present subject matter to provide a universal caddy which is constructed and molded into a one-piece solid structure

It is still another object of the present subject matter to provide a universal caddy for small hand-held electronic devices which has a clamping element.

It is a yet another object of the present subject matter to provide a universal caddy for small hand-held electronic devices which has an arcuate-shaped member for slidingly engaging a shelf or cabinet.

These and other objects of the present subject matter are accomplished by providing a universal caddy comprising a top portion which can be releasably secured to a shelf or cabinet, a main body portion for holding a small electronic device and a base portion which can be utilized on a flat surface.

### BRIEF DESCRIPTION OF DRAWINGS

FIG. 1 is a side view of a first embodiment of the universal caddy of the present subject matter.

FIG. 2 is a front perspective view of a first embodiment of the universal caddy of the present subject matter.

FIG. 3 is a side perspective view of a first embodiment of the universal caddy of the present subject matter, illustrating the clamping means releasably securing the universal caddy to a cabinet shelf.

FIG. 4 is a top perspective view illustrating two universal caddies of the present subject matter, each resting on a flat surface and each holding a hand-held electronic device.

FIG. 5 is a front perspective view illustrating two universal caddies of the present subject matter in an elevated position each releasably secured to a cabinet shelf and each holding a hand-held electronic device.

FIG. 6 is a side view of a second embodiment of the universal caddy of the present subject matter.

FIG. 7 is a front perspective view of a second embodiment of the universal caddy of the present subject matter

FIG. 8A is a side view of a second embodiment of the universal caddy of the present subject matter illustrating the universal caddy prior to engaging a shelf element.

FIG. 8B is a side view of a second embodiment of the universal caddy of the present subject matter illustrating the universal caddy releasably secured to a shelf element.

FIG. 9A is a side view of a second embodiment of the universal caddy of the present subject matter illustrating the universal caddy prior to engaging an extended shelf element.

FIG. 9B is a side view of a second embodiment of the universal caddy of the present subject matter illustrating the universal caddy partially engaging an extended shelf element.

FIG. 9C is a side view of a second embodiment of the universal caddy of the present subject matter illustrating the universal caddy fully engaging an extended shelf element.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

It is to be understood that throughout the specification and claims, the term “hand-held electronic device” is intended to include any small electronic device or smart electronic device such as a smart phone, for example an iPhone, and a smart tablet, such as an iPad. These terms may be used interchangeably throughout the specification and claims and should not be deemed as limiting to a particular hand-held device.

The universal caddy of the present subject matter particularly is designed for holding small electronic devices such as a smart phone or smart tablet. However, it will be understood by those skilled in the art that the universal caddy of the present subject can be used to hold any type of small, hand-held objects and is not necessarily limited to smart electronic devices. More particularly, the universal caddy of the present subject matter is designed in such a manner that it can be used on a flat surface, such as a table, desk, or countertop, to hold a smart electronic device and potentially prevent the item from falling to the floor and cracking or having something being place on top of it, potentially damaging the surface. The universal caddy of the present subject matter can also be elevated to clip onto a cabinet or shelf, thereby allowing smart electronic device to be seen at eye level and freeing up countertop space.

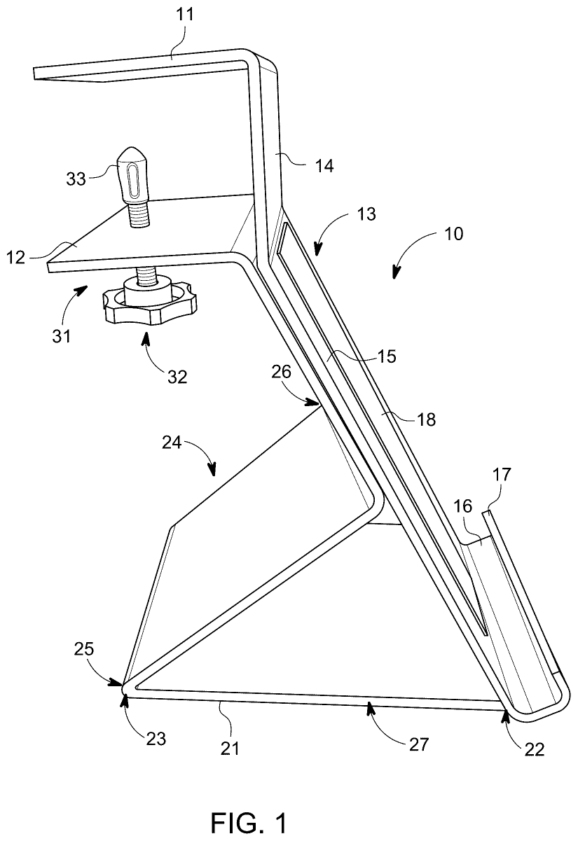

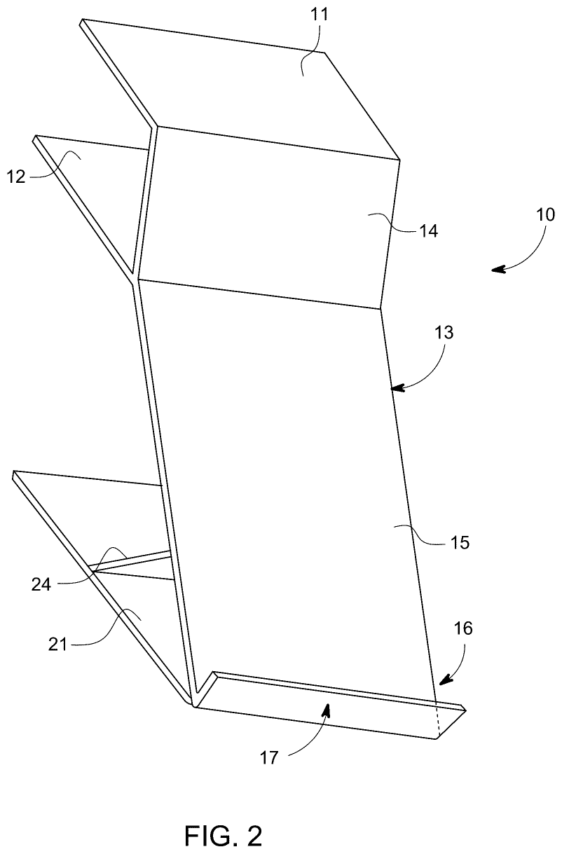

Referring now to FIGS. 1 and 2, in a first embodiment, the universal caddy 10 comprises a top plate 11, a bottom plate 12, a main body member 13 having an upper front plate 14 which is connected to the top plate 11 and to the bottom plate 12, the main body having a face plate 15 which is angled downwardly and outwardly from the upper front plate and terminates in a lower edge 16 having an upwardly curved lip element 17. In the embodiment shown in FIG. 1, the upwardly curbed lip element forms a channel at the lower edge of the face plate of sufficient width to hold and retain a smart device. In an alternate embodiment shown in FIG. 2, the lower edge 16 extends outwardly from the face plate, having sufficient width to accommodate a smart device. The universal caddy 10 further comprises a base member 21 having a proximal end 22 connected near the lower edge 16 of the main body member and a distal end 23. A support plate 24 having a first end 25 is connected to the base member 21 near its distal end 23 and is angled upwardly to the rear side of the main body member 13 and connected to the rear side at its second end 26. The base member 21 has a horizontal underside surface 27 capable of resting on a flat surface. Preferably the undersurface 27 is provided with non-slip means such as a non-slip tape adhered to at least a portion of the underside surface. In another preferred embodiment, at least a portion of the face plate is provided with a grip sheet 18. The universal caddy as thus described can be utilized as a free-standing holder retaining the smart device.

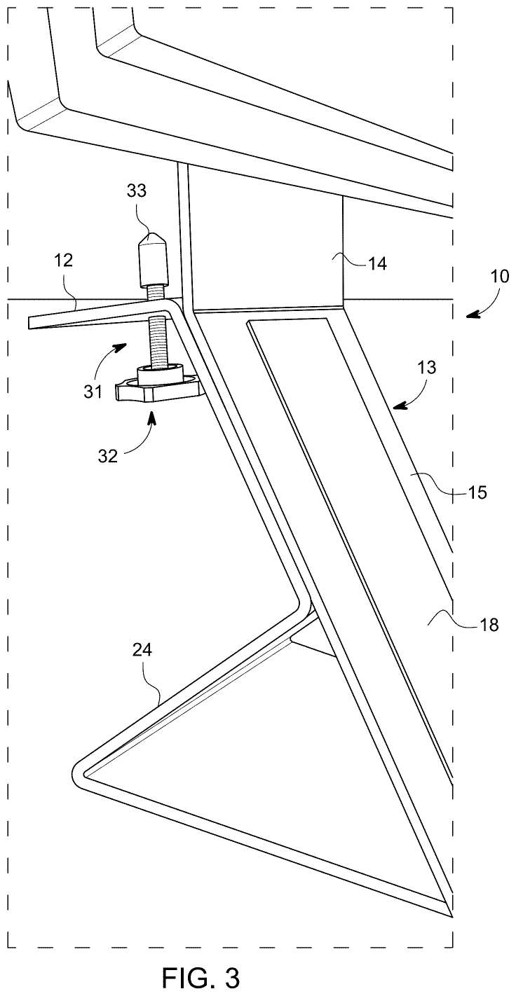

Referring now in particular to FIG. 1 and FIG. 3, the universal caddy 10 further comprises a clamping element 31 which is threadedly secured through the bottom plate 12 having a twist knob 32 below the bottom plate and terminating in a clamp end 33 above the bottom plate. In operation as shown in FIG. 3, the top plate 11 is disposed on the top surface of a shelf, such as a cabinet shelf, and the bottom plate engages the underside of the shelf as the twist knob is turned to releasably secure the clamp end 33 to underside of the shelf. In this manner, the universal caddy of the present subject matter is elevated from the free-standing position to an eye level position. The smart device is retained on the universal caddy in the elevated position. The universal caddy is bonded and molded into a one-piece solid structure.

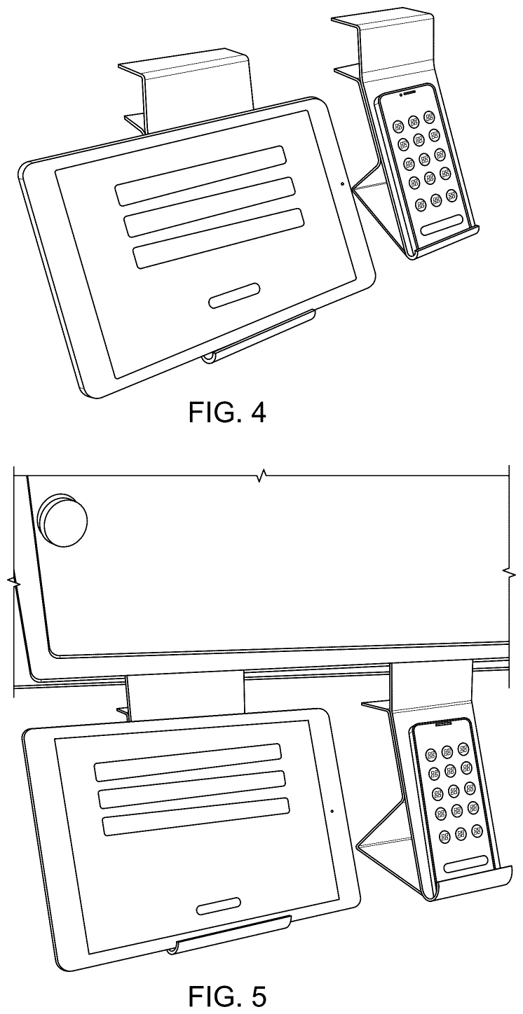

Referring now to FIG. 4, two universal caddies of the present subject matter are shown being utilized as free-standing holders on a countertop, one of the universal caddies having an iPad resting on the lower edge of the lip element and the second universal holding having an iPad resting on the lower edge of the lip element. In FIG. 5, the two universal caddies are releasably secured to the lower shelf of a cabinet and as such are elevated off the countertop.

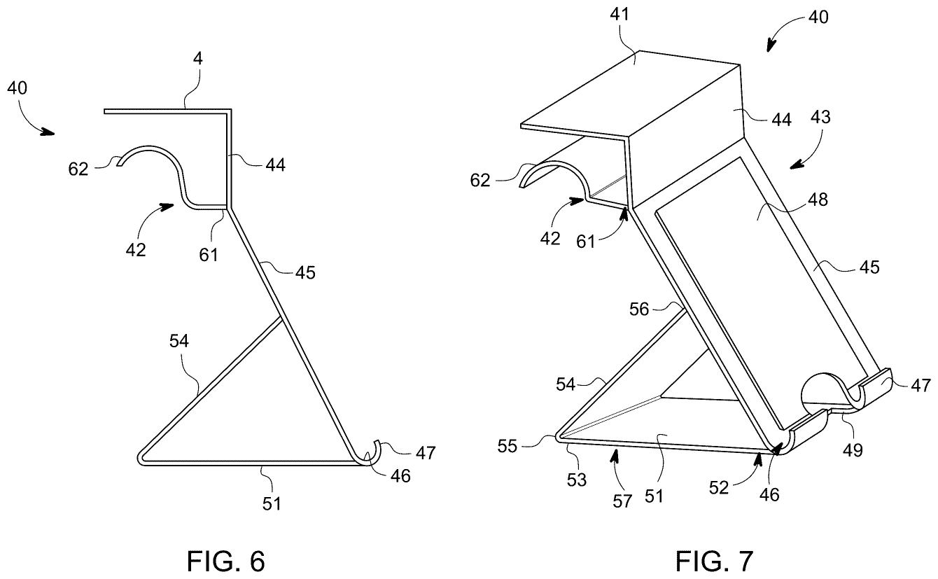

In a second embodiment, the universal caddy of the present subject matter is releasably secured to a shelf or cabinet by means of an arcuate-shaped bottom plate. More specifically and referring to FIGS. 6 and 7, the universal caddy 40 comprises a top plate 41, a bottom plate 42 having a proximal end 51 and an arcuate-shaped distal end 62, a main body 43 having an upper front plate 44 which is connected to the top plate 42 and the proximal end 61 of bottom plate 62, the main body 43 having a face plate 45 which is angled downwardly and outwardly from the upper front plate 44 and terminates in a lower edge 46 having an upwardly curved lip element 47. An aperture 49 is disposed at the lower edge 46, the aperture being of sufficient size to receive a charging cord. In a preferred embodiment, the face plate 45 may be provided with a grip sheet 48. The universal caddy 40 further comprises a base member 51 having a proximal end 52 connected to the main body member 43 and a distal end 53. A support plate 54 having a first end 55 is connected to the base member 51 near the distal end 53 and is angled upwardly to the rear side of the main body member 43 and connected to the rear side at its second end 56. The base member has a horizontal undersurface 27 capable of resting on a flat surface which may be provided with non-slip means such as a non-slip tape adhered to a least a portion of the undersurface. The thus described universal caddy 40 as shown in FIGS. 6 and 7, can be utilized as a free-standing holder retaining a hand-held electronic device.

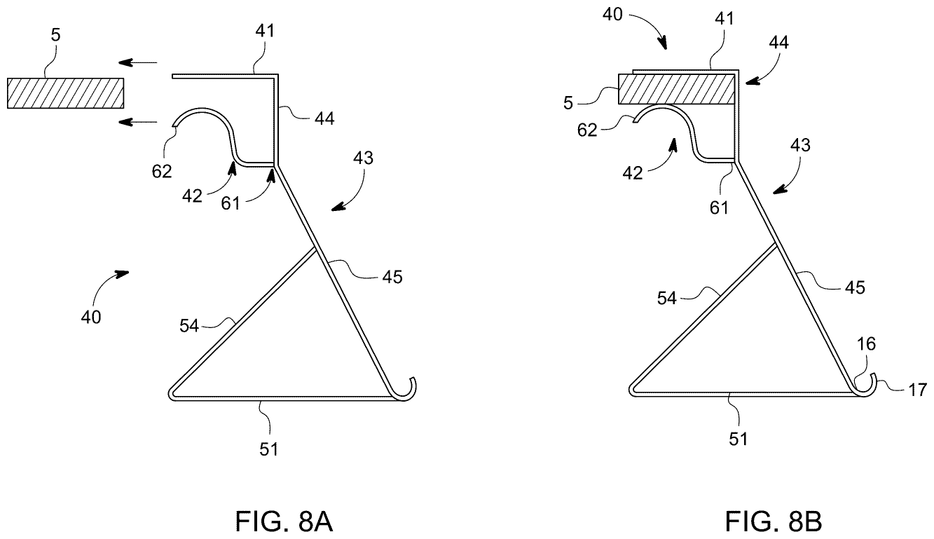

Referring now to FIGS. 8A and 8B, to elevate this second embodiment of the universal caddy of the present subject matter, a standard shelf portion S is shown in FIG. 8A prior to engagement with the top plate 41 and arcuate-shaped distal end 62 of bottom plate 42 of the universal caddy. In FIG. 8B, the caddy is lined up in front of the shelf and gently slid onto the shelf S, the top plate 41 being slid over the upper side of the shelf and the arcuate-shaped distal end 62 and bottom plate 42 is slid under the shelf and gently pressed in a forward manner. When all three contact points are touching the shelf S, the universal caddy 40 is thus releasably secured to the shelf S.

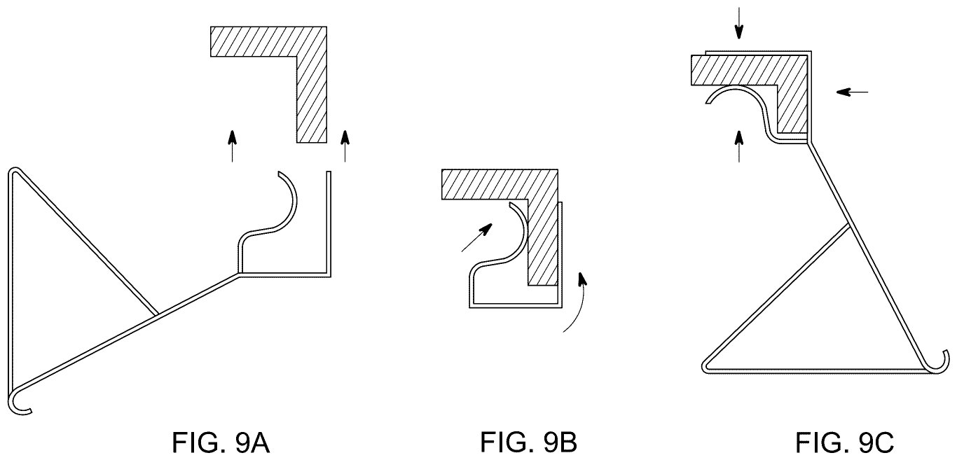

FIGS. 9A, 9B and 9C illustrate how the universal caddy 40 is releasably secured to an extended shelf ES such as a cabinet shelf. The caddy is turned with the face plate 44 downward, the top and bottom plates are lined on the extended shelf and gently slid to the underneath of the extended shelf ES as shown in FIG. 9B. Once the caddy contacts the underside of the extended shelf, the caddy 40 is gently rotated counter clockwise and pushed upward such that top plate 41 is slid over the upper side of the extended shelf ES. When all three contact points are touching the extended shelf ES, the universal caddy 40 is thus releasably secured to the extended shelf ES.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A universal caddy for a hand-held electronic device capable of resting on a flat surface and which can be attached to a shelf comprising:
a. a top plate;
b. a bottom plate disposed below said top plate and horizontal thereto;
c. a main body member having an upper front plate connected to said top plate and to said bottom plate and having a face plate angled downwardly and outwardly from said upper front plate terminating in a lower edge having an upwardly curved lip element;
d. a base member having a proximal end connected near said lower edge of said main body member and a distal end; and
e. a support plate having a first end and a second end, said first end connected near the said distal end of said base member, said support plate angled upwardly to the rear side of said main body member and connected to said rear side of said main body member at said second end,
wherein said base member has a horizontal underside surface capable of resting on a flat surface, and wherein the space formed between said top plate and said bottom plate is of sufficient size that it can be releasably secured to said shelf in such a manner that said top plate rests on the top surface of said shelf and said bottom plate engages the underside of said shelf, thereby providing said universal caddy with means to be elevated.

2. The universal caddy in accordance with claim 1, further comprising a grip sheet disposed on at least a portion of said face plate.

3. The universal caddy in accordance with claim 2, wherein said grip sheet is in the form of a non-slip tape adhered to said at least a portion of said face plate.

4. The universal caddy in accordance with claim 1, wherein said lip element is of sufficient width to receive an edge of said hand-held electronic device.

5. The universal caddy in accordance with claim 1, further comprising a clamping element having a twist knob which is threadedly secured through said bottom plate to said shelf.

6. The universal caddy in accordance with claim 1, wherein said bottom plate is provided with an arcuate end distal from said main body member.

7. The universal caddy in accordance with claim 6, wherein said arcuate end of said bottom plate clips under said shelf and creates a tension to releasably secure said universal caddy to said shelf.

8. The universal caddy in accordance with claim 1, further comprising an aperture near said lower edge of said main body, said aperture being of sufficient size to receive a charging cord to attach to said hand-held electronic device.

9. The universal caddy in accordance with claim 1, wherein at least a portion of the underside of said base plate is provided with non-slip means.

10. The universal caddy in accordance with claim 1, wherein said non-slip means is in the form of a non-slip tape adhered thereto.

11. The universal caddy in accordance with claim 1, wherein said universal caddy is bonded and molded into one solid piece.

12. A universal caddy for a hand-held electronic device capable of resting on a flat surface and which can be attached to a shelf comprising:
a. a top plate;
b. a bottom plate disposed below said top plate and horizontal thereto;
c. a main body member having an upper front plate connected to said top plate and to said bottom plate and having a face plate angled downwardly and outwardly from said upper front plate terminating in a lower edge having an upwardly curved lip element;
d. a base member having a proximal end connected near said lower edge of said main body member and a distal end;
e. a support plate having a first end and a second end, said first end connected near the said distal end of said base member, said support plate angled upwardly to the rear side of said main body member and connected to said rear side of said main body member at said second end; and
f. a clamping element having a twist knob which is threadedly secured through said bottom plate,
wherein said base member has a horizontal underside surface capable of resting on a flat surface, and wherein the space formed between said top plate and said bottom plate is of sufficient size that it can be releasably secured to said shelf in such a manner that said top plate rests on the top surface of said shelf and said bottom plate engages the underside of said shelf and is releasably secured to said underside of said shelf by said clamping element, thereby providing said universal caddy with means to be elevated.

13. The universal caddy in accordance with claim 12, further comprising a grip sheet disposed on at least a portion of said face plate.

14. The universal caddy in accordance with claim 13, wherein said grip sheet is in the form of a non-slip tape adhered to said at least a portion of said face plate.

15. The universal caddy in accordance with claim 12, further comprising an aperture near said lower edge of said main body, said aperture being of sufficient size to receive a charging cord to attach to said hand-help electronic device.

16. The universal caddy in accordance with claim 12, wherein at least a portion of the underside of said base plate is provided with non-slip means.

17. The universal caddy in accordance with claim 16, wherein said non-slip means is in the form of a non-slip tape adhered thereto.

18. The universal caddy in accordance with claim 12, wherein said universal caddy is bonded and molded into one solid piece.

19. A universal caddy for a hand-held electronic device capable of resting on a flat surface and which can be attached to a shelf comprising:
a. a top plate;
b. a bottom plate disposed below said top plate and horizontal thereto, said bottom plate a proximal end and an arcuate-shaped distal end;
c. a main body member having an upper front plate connected to said top plate and to said proximal end of said bottom plate, and having a face plate angled downwardly and outwardly from said upper front plate terminating in a lower edge having an upwardly curved lip element;
d. a base member having a proximal end connected near said lower edge of said main body member and a distal end; and
e. a support plate having a first end and a second end, said first end connected near the said distal end of said base member, said support plate angled upwardly to the rear side of said main body member and connected to said rear side of said main body member at said second end,
wherein said base member has a horizontal underside surface capable of resting on a flat surface, and wherein the space formed between said top plate and said bottom plate is of sufficient size that it can be releasably secured to said shelf in such a manner that said top plate rests on the top surface of said shelf and said arcuate end of said bottom plate clips under said shelf and creates a tension therebetween as it the underside of said shelf, thereby providing said universal caddy with means to be elevated.

20. The universal caddy in accordance with claim 19, further comprising a grip sheet disposed on at least a portion of said face plate.

21. The universal caddy in accordance with claim 20, wherein said grip sheet is in the form of a non-slip tape adhered to said at least a portion of said face plate.

22. The universal caddy in accordance with claim 19, further comprising an aperture near said lower edge of said main body, said aperture being of sufficient size to receive a charging cord to attach to said hand-help electronic device.

23. The universal caddy in accordance with claim 19, wherein at least a portion of the underside of said base plate is provided with non-slip means.

24. The universal caddy in accordance with claim 20, wherein said non-slip means is in the form of a non-slip tape adhered thereto.

25. The universal caddy in accordance with claim 19, wherein said universal caddy is bonded and molded into one solid piece.
